(19) United States
(12) Patent Application Publication
(10) Pub. No.: US 2004/0169681 A1
(43) Pub. Date: Sep. 2, 2004

(54) Pictorial timeline

(76) Inventors: Ann-Martine Josette Van Kesteren, Eindhoven (NL); Marieke Verspaandonk, Eindhoven (NL); Peter George Matthews, Eindhoven (NL)

Correspondence Address: Philips Electronics North America Corporation, Corporate Patent Counsel, PO Box 3001, Briarcliff Manor, NY, 10510, US

(21) Appl. No.: 10/480,661

(22) PCT Filed: Jun. 28, 2002
(86) PCT No.: PCT/IB02/02490

(30) Foreign Application Priority Data
Jun. 29, 2001 (EP) 01202519.3
Sep. 11, 2001 (EP) 01203422.9

(51) Int. Cl. G09G 5/00

(52) U.S. Cl. 345/764; 345/963

(57) ABSTRACT

The system (300) displays a sequence of images on a display device (308) in a display order that corresponds with the order of the images in the sequence. One of the images is selected as the current image and is displayed in full. Other images of the sequence are displayed in part. A user can scroll through the sequence of image, whereby the images are shifted by a position in the display order and whereby a neighboring images is fully shown as the current image.

The invention relates to a method of displaying a sequence of images on a display device, in which sequence the images are ordered in a sequence order according to a predetermined criterion, the method comprising: selecting a current image from the images, and simultaneously displaying the current image and further images from the images on the display device in a display order corresponding with the sequence order.

The invention further relates to a system for displaying a sequence of images on a display device, in which sequence the images are ordered in a sequence order according to a predetermined criterion, the system comprising: selection means for selecting a current image from the images, and display means for simultaneously displaying the current image and further images from the images on the display device in a display order corresponding with the sequence order.

U.S. Pat. No. 6,034,683 describes a system that displays scheduled events, like meetings. This system displays a time line in the form of a bar with indications of the hours inside the bar. The scheduled events are displayed as images, in particular as boxes, along the bar at positions that correspond with the times the events are to take place. A user can navigate through the time line by clicking the position in the time line bar that corresponds with a desired time. The bar and the events may be displayed inside a window that is provided with a scroll bar. This scroll bar allows navigating to positions on the time line bar that are currently not displayed in the window. Furthermore, the system provides a day tab for selecting a certain day, a week tab for selecting a certain week and a month tab for selecting a certain month in time.

It is an object of the invention to provide a method according to the preamble offering the user a comparatively good context for the current image. This object is achieved according to the invention in that the current image is displayed substantially in full and the further images are displayed in part. By displaying the further images of the sequence in part, a larger number of the images of the sequence are offered to the user in a given area of the display device. This improves the user's understanding of the relation the current image has with other images in the sequence. Furthermore, by showing a portion of each of the further images and the whole of the current image, it is immediately clear which of the images the current image is. This also improves the ease of comprehension of the displayed sequence of images.

An embodiment of the method according to the invention is described in claim 2. The invention can advantageously be applied to a sequence of images that are ordered according to their time of creation, since it then provides the user the historic context of the current image in an easy way.

An embodiment of the method according to the invention is described in claim 3. The overlapping roof-tile like display of the further images is an attractive and space efficient way of displaying these images. It is a natural way that allows easy comprehension as to which image is prior to which other image in the sequence. Furthermore, thanks to the overlapping roof-tile like display, a similar section of each of the further images is shown. This makes it easier to compare the images with each other and to see certain differences between the images. In particular when the images are organized in a time sequential order, changes over time between the images can easily be spotted.

An embodiment of the method according to the invention is described in claim 4. Displaying the parts of the earlier images in the sequence at the left side of the current image, which is fully displayed, and the parts of the later images at the right side, is an attractive, natural way to display the sequence. It is easy for the user to recognize the current image and to understand the context of the current image in relation to the other images of the sequence.

An embodiment of the method according to the invention is described in claim 5. Scrolling through the displayed sequence of images allows the user to view in detail another image than the current image. It provides an easy way to navigate through the sequence of images.

An embodiment of the method according to the invention is described in claim 6. The user selects to scroll to a certain part in the sequence, by simply moving the indicium on the display device beyond the side of the current image where the images in that certain part of the sequence are displayed. This is a natural and easy to understand operation for the user. Furthermore, scrolling in this embodiment is controlled without requiring additional control buttons or control bars. This makes that the user is not confronted with such additional navigation control items and that the user does not need to be acquainted with such items. Also, the absence of such control items saves space on the display device.

It is a further object of the invention to provide a system according to the preamble offering the user a relatively good context for the current image. This object is achieved according to the invention in a system that is characterized in that the display means is arranged to display the current image substantially in full and to display the further images in part.

The invention and its attendant advantages will be further elucidated with the aid of exemplary embodiments and the accompanying schematic drawings, wherein:

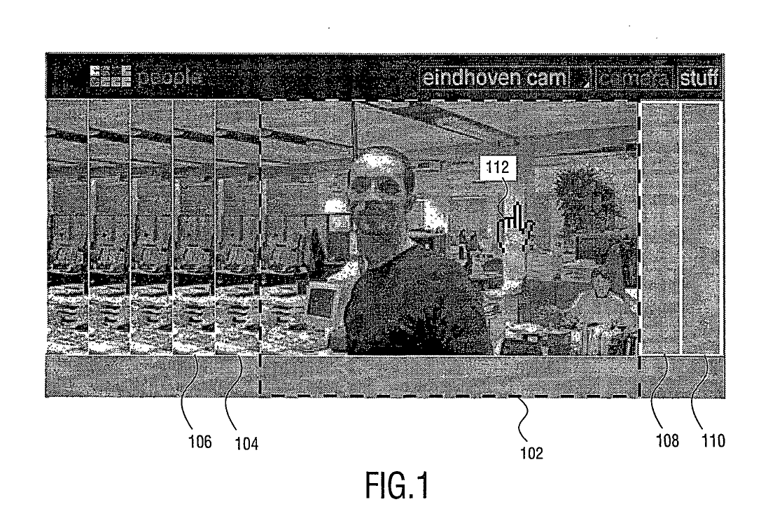

FIG. 1 shows a sequence of images displayed according to the invention,

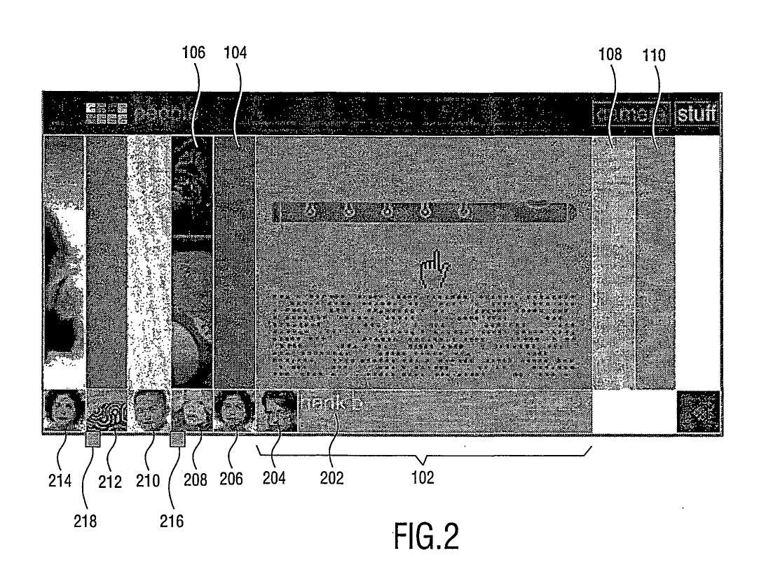

FIG. 2 shows an alternative application of displaying a sequence of images according to the invention, and

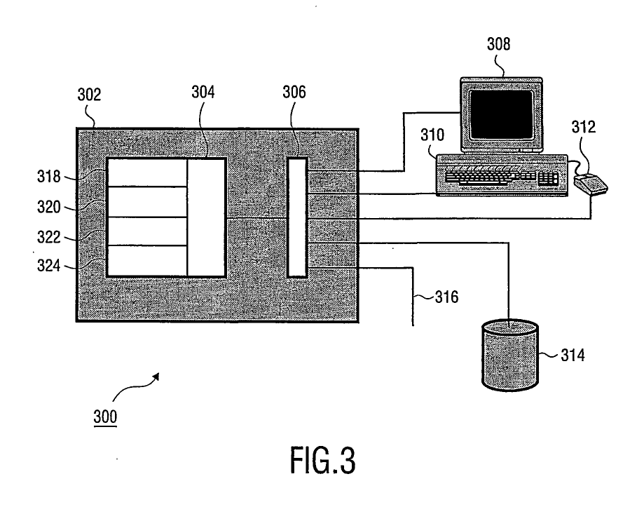

FIG. 3 schematically shows a system according to the invention.

Corresponding features in the various Figures are denoted by the same reference symbols.

FIG. 1 shows a sequence of images displayed according to the invention. In this embodiment, the images have been generated by a webcam taking images of an environment from a fixed position and at certain points in time. The sequence of images represents a history of activities that have taken place in that environment up to the present time. On the display screen is a so-called stage area 102 in which the current image of the sequence is displayed in full. The current image may be the most recent image from the webcam, as shown in FIG. 1, but may also be an image taken some time ago and selected as the current image, e.g. for detailed display. Images that are earlier in the sequence than the current image are displayed at the left side of the stage area. Of these images, only a relatively small part is shown in small areas left to the stage area. For example, part of the predecessor of the current image is shown in the first neighboring area 104 and part of the predecessor of the predecessor is shown in the second neighboring area 106. If there are later images in the sequence than the current image, parts of these later images are shown to the right of the stage area in a similar way. In the example of FIG. 1, the next image in area 108 and a still later image in area 110.

The sequence of images is displayed from left to right on the display device in an order that corresponds with the order of the images in the sequence. The current image is shown in full, images earlier in the sequence are shown partially and to the left of the current image, and images later in the sequence are shown partially and to the right of the current image. This provides the user with a clear and easy to understand overview of the sequence of images. The relation between the currently selected image and the other images in the sequence is easy to see from the display. In this embodiment, the order in the sequence is the order in time that the images have been taken. The displayed sequence constitutes a timeline for the displayed images. However, the invention is not restricted to a webcam application with a sequence of images that are ordered with respect to time and other order criteria are also possible, for example the position where a certain image is taken. Furthermore, the display orientation from left to right could be changed. For example, the images could be displayed from the bottom of the display device to the top of the display device, corresponding with the order of the images in the sequence.

The user can scroll through the images displayed on the timeline by means of a cursor 112 operable through a user input device like a mouse. If the cursor is inside the stage area and not close to the left or right edge, the cursor is for the support of applications that can be activated, e.g. by a mouse click. Such an application may operate on the content of the image, e.g. an editor for adding a review remark to the image. When the cursor is moved to the left side of the stage area and comes in the vicinity of the edge, the system enters into a scroll mode. The generic cursor changes into a pointing cursor and gets a shape of an arrow. The user is now able to scroll through the timeline. By moving the pointing cursor to the left of the stage area, the earlier image fully appears in the stage area thereby replacing the current image. It looks as if the timeline has shifted one place to the right. By moving the pointing cursor further away, i.e. further to the left, from the stage area the scrolling speed becomes higher. Instead of moving the generic cursor to the left edge of the stage area, it may also be moved to the right edge. In that case, the subsequent image replaces the image currently shown in the stage area. Moving the pointing cursor to the right makes that the timeline shifts to the left.

Scrolling makes that a neighboring image replaces the image currently shown in the stage area. The thus replaced image reappears as a partly covered image at the side of the stage area opposing the neighboring image. Thus, when the pointing cursor is moved to the left of the stage area, the previous image, which was shown partly shown at the left side of the stage area, replaces the current image shown in the stage area. This current image is subsequently shown as partly covered image at the right side of the stage area. Scrolling to the right direction results in a similar operation, but in the opposite direction. Thus, when the pointing cursor is moved to the right of the stage area, the next image, which was shown partly shown at the right side of the stage area, replaces the current image shown in the stage area. This current image is subsequently shown as partly covered image at the left side of the stage area.

The stage area can be regarded as a view on the time ordered collection of images. This view can be panned over the timeline. By showing the current image, in direct relation with earlier images (at the left side) and later images (at the right side), the user is given the historic context of this current image.

FIG. 2 shows an alternative application of displaying a sequence of images according to the invention. In this application, a user submits contributions that may be viewed and accessed by other users of the system. This submission of contributions is similar to putting messages on a bulletin board and sending e-mail to a group of users. The system displays these contributions as a sequence of images. A user selects one of the images as the current image, which is displayed in full in the stage area 102. Other contributions are displayed as partial images in neighboring areas 104-110 according to the order of the contributions in the sequence. The order in the sequence is the time at which the contribution is submitted, but another sequence order can be used. Navigating through the sequence is carried out in the same way as described above in connection with FIG. 1.

An identifier 202 is shown indicating the person who has submitted the contribution displayed in the stage area. The identifier 202 may be the name of the person. Furthermore, a small photograph 204 of the submitter of the current contribution is displayed again showing to the user the person who has submitted this particular contribution. In addition to the current contribution, photographs 206-214 of the respective submitters are shown for further contributions of the sequence, which are only shown in part. This makes it easier to identify the contributions and to help the user in making a selection.

A further, optional refinement for helping the user in making a selection is by adding markers, like 216 and 218, to contributions by persons of a pre-selected group of persons. The user defines a group of persons, contributions of who must be signaled by the system. For each of the displayed contribution, whether displayed in full in the stage area or displayed in part in the neighboring areas, the system checks whether it has been submitted by a person in that group. If this is the case then a marker is attached to that contribution. In this way, the user can easily find the contributions by the group in which he or she has a special interest. The user can scroll through the sequence to such a contribution as described above. In a still further refinement, the system only displays the contributions made by persons from the interest group and filters out all other contributions. This is particularly useful if there are many users in the system, submitting many contributions to the timeline.

FIG. 3 schematically shows a system according to the invention. This system is arranged to display a sequence of images as described above. The system is implemented on a general purpose computer 302, like a personal computer, according to a known architecture. The various functions of the system in this embodiment are realized in respective software units as described below. This is an exemplary embodiment and another way of mapping the functions onto units is also feasible. The system has a working memory 304 into which the various software units are loaded for execution. The further structure for executing and controlling operation of the computer is not shown in FIG. 3. The computer has an interface 306 for communicating with the peripheral devices. The system has a display device 308 on which the images are displayed. Furthermore, the system has input devices, like keyboard 310 and mouse 312, with which a user can enter commands and data. The system has a storage device 314 on which software and other data may be stored. This storage device is a magnetic disk drive but other suitable storage devices may be used. Furthermore, the system has a network connection 316 for connecting to a central server in the network. This server typically contains the images that are displayed by system 300. Furthermore, this server may contain the application software or part of the application software, comprising the software units. However, this application software could also be stored on the local storage device 314.

The application software for performing the functions of the system has a number of software units. The system has a selection unit 318 for selecting one of the images of the sequence as the current image. This current image may by default be the most recently added image or may be an image specifically selected by the user. The system further has a display unit 320 for displaying the sequence of images in a display order that corresponds with the order in the sequence. This displaying can be in a static way or in a dynamic, scrolling, way as described above in connection with FIGS. 1 and 2. Furthermore, the system optionally comprises a scroll unit 322 for implementing scrolling of the sequence of images. The user enters scroll commands, like the scrolling direction and the scrolling, by means of mouse 312. Subsequently, the scroll means determine which images are to be replaced by which other images in the displayed sequence. The system further optionally comprises a dividing unit 324 for dividing the sequence of images into two groups with respect to the current image: one group with images that are the predecessors of the current image having regard to the sequence order and one group with images that are the successors of the current image having regard to the sequence order.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

1. A method of displaying a sequence of images on a display device, in which sequence the images are ordered in a sequence order according to a predetermined criterion, the method comprising:
selecting a current image from the images, and
simultaneously displaying the current image and further images from the images
on the display device in a display order corresponding with the sequence order, characterized in that the current image is displayed substantially in full and the further images are displayed in part.

2. A method as claimed in claim 1, wherein the images of the sequence are ordered according to times at which the respective images have been created.

3. A method as claimed in claim 1, wherein the further images are displayed overlapping like roof-tiles

4. A method as claimed in claim 3,
wherein the further images are divided into a first group with predecessors of the current image in the sequence order and a second group with successors of the current image in the sequence order,
wherein the further images of the first group are displayed like roof-tiles at the left side of the current image, whereby only a left portion of each of these further images is displayed, and
wherein the further images of the second group are displayed like roof-tiles at the right side of the current image, whereby only a right portion of each of these further images is displayed.

5. A method as claimed in claim 1, wherein a user is enabled to scroll through the sequence of images in a selected scroll direction, the method comprising:
determining which of the further images is the succeeding current image of the current image with respect to the sequence order and the selected scroll direction,
determining a succeeding image for each of the further images, if any, and
displaying the succeeding current image by replacing the current image and displaying the succeeding images by replacing each of the respective further images.

6. A method as claimed in claim 5,
wherein the further images are divided into a first group with predecessors of the current image in the sequence order and a second group with successors of the current image in the sequence order,
wherein the first group is displayed adjacent to a first side of the current image and the second group is displayed adjacent to a second side of the current image, and
wherein the user is enabled to select the scroll direction backwards in the sequence by moving an indicium from inside the current image beyond the first side of the current image and to select the scroll direction forwards in the sequence by moving the indicium from inside the current image beyond the second side of the image.

7. A method as claimed in claim 6, wherein the scrolling through the sequence of images is executed with a scroll speed that is dependent on the distance the indicium is moved beyond the particular side of the current image.

8. A method as claimed in claim 1, wherein a first group of the images has been submitted by a first source and a second group of the images has been submitted by a second source, and wherein each of the images of the first and the second groups is displayed with a source indication indicating the source of that image.

9. A method as claimed in claim 1, wherein the images are generated by a webcam.

10. A system (300) for displaying a sequence of images on a display device (308), in which sequence the images are ordered in a sequence order according to a predetermined criterion, the system comprising:
selection means (318) for selecting a current image from the images, and
display means (320) for simultaneously displaying the current image and further images from the images on the display device (308) in a display order corresponding with the sequence order,
characterized in that the display means (320) is arranged to display the current image substantially in full and to display the further images in part.

11. A system (300) as claimed in claim 10, comprising scroll means (322) for under control of a user scrolling through the sequences of images in a selected scroll direction, the scroll means (322) being arranged to determine which of the further images is the succeeding current image of the current image with respect to the sequence order and the selected scroll direction and to determine a succeeding image for each of the further images, if any, and in which system the display means (320) are arranged for under control of the scroll means displaying the succeeding current image by replacing the current image and displaying the succeeding images by replacing each of the respective further images.

12. A system (300) as claimed in claim 11,
wherein the system further comprises dividing means (324) for dividing the further images into a first group with predecessors of the current image in the sequence order and a second group with successors of the current image in the sequence order,
wherein the display means (320) is arranged to display the first group adjacent to a first side of the current image and to display the second group adjacent to a second side of the current image, and
wherein the scroll means (322) is arranged to enable the user to select the scroll direction backwards in the sequence by moving an indicium (112) from inside the current image beyond the first side of the current image and to select the scroll direction forwards in the sequence by moving the indicium (112) from inside the current image beyond the second side of the image.
